(19) United States
(12) Patent Application Publication
(10) Pub. No.: US 2013/0346105 A1
(43) Pub. Date: Dec. 26, 2013

(54) COLLABORATIVE MANAGEMENT OF NURSING RISK ASSESSMENTS

(71) Applicants: HUGH RYAN, LEE'S SUMMIT, MO (US); SHELLY WILSON, LEE'S SUMMIT, MO (US); KYLE CARSON, INDEPENDENCE, MO (US); DONNA J. CAPPO, INDEPENDENCE, MO (US)

(72) Inventors: HUGH RYAN, LEE'S SUMMIT, MO (US); SHELLY WILSON, LEE'S SUMMIT, MO (US); KYLE CARSON, INDEPENDENCE, MO (US); DONNA J. CAPPO, INDEPENDENCE, MO (US)

(73) Assignee: CERNER INNOVATION, INC., OVERLAND PARK, KS (US)

(21) Appl. No.: 13/530,331

(22) Filed: Jun. 22, 2012

(51) Int. Cl. G06Q 50/24

(52) U.S. Cl. 705/3

(57) ABSTRACT

Methods, computer systems, and computer storage media are provided for using patient information stored in association with the patient's electronic medical record at a first healthcare facility to generate a comprehensive nursing risk assessment for the patient. The comprehensive nursing risk assessment includes nursing risk scenarios for which the patient is at risk and nursing risk prevention measures designed to reduce that risk. The comprehensive nursing risk assessment can be utilized by clinicians other than clinicians in a nursing-type role. The comprehensive nursing risk assessment can also be communicated to other healthcare facilities that are either concurrently caring for the patient with the first healthcare facility or scheduled to care for the patient after the patient is discharged from the first healthcare facility.

### BACKGROUND

Nurses involved in patient care often spend a large amount of time performing nursing risk assessments on patients. The objective of a nursing risk assessment is to identify patients at risk for one or more nursing risk scenarios. In general, a nursing risk scenario is a risk setting that can be decreased or eliminated by one or more nursing actions or prevention measures that are within the scope of a nurse's expertise and practice. Nurses perform nursing risk assessments by questioning the patient and the patient's family, performing physical assessment activities, and manually reviewing the patient's file to identify certain risk factors. This can be a time-consuming and laborious process. It has been estimated that nurses can spend up to 50 percent of their time performing risk assessments—time that would be well spent on providing hands-on patient care. Even after the time and effort spent on identifying and documenting nursing risk assessments, the information is often only available to other nurses caring for the patient. Physicians and other caretakers generally do not have access to this valuable information. Further, this information is rarely shared with other healthcare facilities involved in the patient's care. Instead, these other facilities perform their own assessments, which consume valuable nursing resources and duplicates efforts that have already been carried out at the first healthcare facility.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief, and at a high level, methods, systems, and computer storage media provide for generating a comprehensive nursing risk assessment for a patient. A comprehensive nursing risk assessment is a complete evaluation of the patient's risk for one or more nursing risk scenarios based on the patient's medical records, physical assessment activities, and interviews with the patient. In turn, a nursing risk scenario is a condition for which the patient is at risk unless appropriate nursing-related intervention or prevention measures are instituted. Nursing risk scenarios may include conditions such as falls, delirium, venous-thrombo-embolism, and the like. The nursing-related intervention or prevention measures are those that fall within the scope of a nurse's practice as defined by state law, and/or as defined by the healthcare facility where the nurse is employed.

The comprehensive nursing risk assessment is generated by accessing an electronic medical record (EMR) associated with the patient. The EMR is searched to identify if the patient meets certain risk factors for nursing risk scenarios. If the patient is at risk for a nursing risk scenario, appropriate prevention measures are identified for the nursing risk scenario. All of the patient's risks and prevention measures are aggregated and used to generate a comprehensive nursing risk assessment that is presented not only to nurses but also to other clinicians involved in the patient's care. Additionally, the comprehensive nursing risk assessment can be communicated to other healthcare facilities that are or will be involved in the patient's care.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a block diagram of an exemplary system for creating a comprehensive nursing risk assessment suitable to implement embodiments of the present invention;

FIG. 3 is an exemplary graphical user interface presenting a comprehensive nursing risk assessment in combination with a general patient summary in accordance with an embodiment of the present invention;

FIG. 4 is an excerpted portion of the graphical user interface of FIG. 3 presenting icons used in accordance with an embodiment of the present invention;

FIG. 5 is an exemplary graphical user interface for presenting a comprehensive nursing risk assessment in accordance with an embodiment of the present invention;

FIG. 6 is a flow diagram illustrating an exemplary method of generating a comprehensive nursing risk assessment in accordance with an embodiment of the present invention;

FIG. 7 is a flow diagram illustrating an exemplary method of generating a comprehensive nursing risk assessment at a first healthcare facility and communicating the comprehensive nursing risk assessment to a second healthcare facility in accordance with an embodiment of the present invention; and

FIG. 8 is a flow diagram illustrating an exemplary method of generating a comprehensive nursing risk assessment and presenting the comprehensive nursing risk assessment to a clinician in a role other than a nursing role in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer storage media for generating a comprehensive nursing risk assessment for a patient. The comprehensive nursing risk assessment is generated by accessing an electronic medical record (EMR) associated with the patient. The EMR is searched to identify if the patient meets certain risk factors for nursing risk scenarios. If the patient is at risk for a nursing risk scenario, appropriate prevention measures are identified for the nursing risk scenario. All of the patient's risks and prevention measures are aggregated and used to generate a comprehensive nursing risk assessment. The comprehensive nursing risk assessment is presented on a user interface.

The comprehensive nursing risk assessment can be used not only by other nurses caring for the patient, but also by physicians and other clinicians (respiratory therapists, occupational therapist, pharmacists, etc.) involved in the patient's care. For example, the comprehensive nursing risk assessment may be presented in conjunction with a general patient summary or a clinician worklist. Additionally, the comprehensive nursing risk assessment can be communicated to other healthcare facilities that are or will be involved in the patient's care.

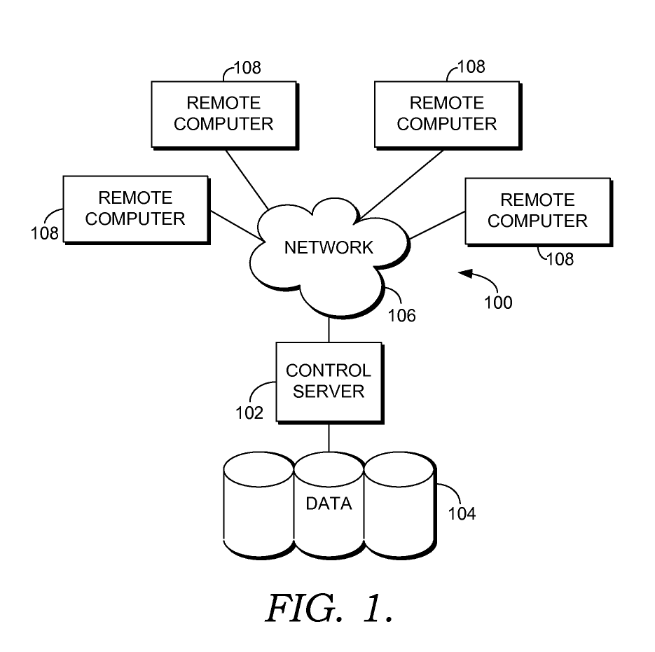

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

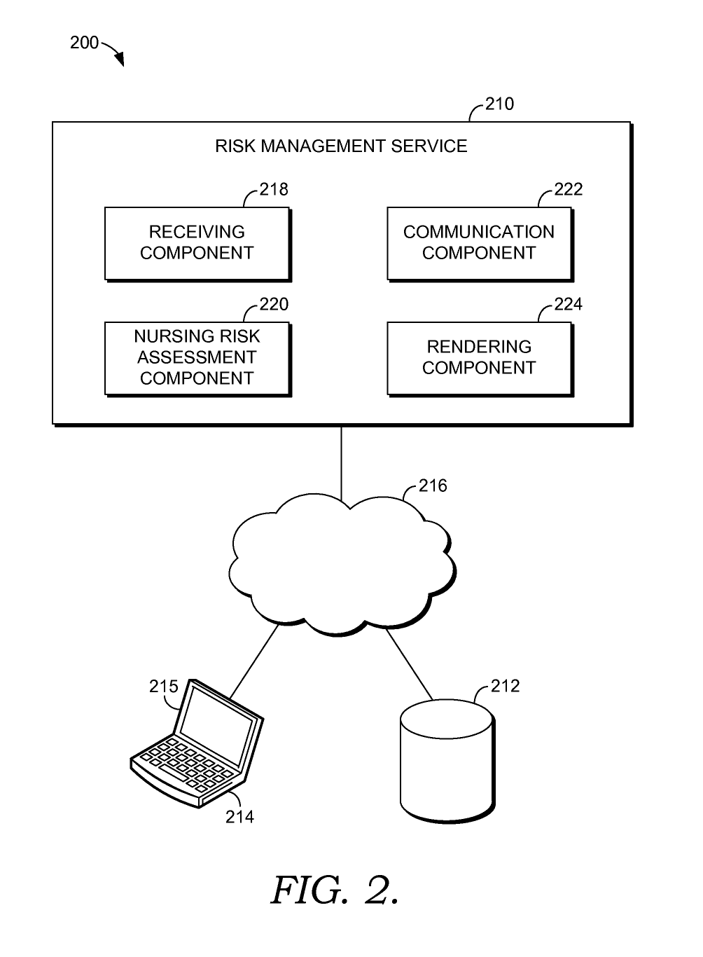

Turning now to FIG. 2, an exemplary computing system environment 200 is depicted suitable for use in implementing embodiments of the present invention. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a risk management service 210, a data store 212, and an end-user computing device 214 with a display screen 215 all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

In some embodiments, one or more of the illustrated components/modules may be implemented as stand-alone applications. In other embodiments, one or more of the illustrated components/modules may be integrated directly into the operating system of the risk management service 210. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the risk management service 210 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 212 is configured to store information for use by, for example, the risk management service 210. The information stored in association with the data store 212 is configured to be searchable for one or more items of information stored in association therewith. The information stored in association with the data store 212 may comprise general information used by the risk management service 210.

For example, the data store 212 may store information concerning nursing risk assessments. Nursing risk assessment information includes one or more nursing risk scenarios. Nursing risk scenarios are numerous but some representative examples include pressure ulcer risk, medication non-adherence risk, risk for delirium or depression, risk for veno-thrombo-embolism (VTE), risk of restraints, risk of alcohol withdrawal, risk for falls, risk for ineffective nutrition, and/or risk for ventilator-acquired pneumonia (VAP). The nursing risk assessment information also includes risk factors associated with the nursing risk scenarios. Using pressure ulcer risk as an exemplary nursing risk scenario, risk factors may include paralysis, coma, obesity, pre-existing conditions such as diabetes mellitus, poor nutrition, and the like.

The nursing risk assessment information additionally includes nursing risk prevention measures designed to reduce the occurrence of the nursing risk scenarios; each nursing risk scenario may have an associated set of nursing risk prevention measures. These prevention measures may be specific to a healthcare facility, they may be prevention measures promulgated by national governing bodies or health agencies and applicable to any number of healthcare facilities, or they may be a combination of both. The data store 212 may store nursing risk assessment information concerning one healthcare facility or multiple healthcare facilities. Nursing risk assessment information stored in association with the data store 212 may be updated as new information (e.g., risk scenarios, risk factors, or prevention measures) becomes available.

The data store 212 may also store electronic medical records (EMRs) of patients associated with one or more healthcare facilities. EMRs may comprise electronic clinical documents such as images, clinical notes, orders, summaries, reports, analyses, or other types of electronic medical documentation relevant to a particular patient's condition and/or treatment. Electronic clinical documents contain various types of information relevant to the condition and/or treatment of a particular patient and can include information relating to, for example, patient identification information, images, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, and a host of other relevant clinical information.

Additionally, the data store 212 may store information concerning decision-support algorithms, reference materials, standards of care, recommendation protocols, and the like. This information may be specific to a healthcare facility, or the information may be promulgated by, for example, nationally-recognized medical organizations or governing bodies.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the risk management service 210, the end-user computing device 214, and/or any combination thereof.

As shown, the end-user computing device 214 includes a display screen 215. The display screen 215 is configured to display information to the user of the end-user computing device 214, for instance, information relevant to communications initiated by and/or received by the end-user computing device 214, nursing risk assessment information, and/or the like. Embodiments are not intended to be limited to visual display but rather may also include audio presentation, combined audio/visual presentation, and the like. The end-user computing device 214 may be any type of display device suitable for presenting a graphical user interface. Such computing devices may include, without limitation, a computer, such as, for example, any of the remote computers 108 described above with reference to FIG. 1. Other types of display devices may include tablet PCs, PDAs, mobile phones, smart phones, as well as conventional display devices such as televisions.

Components of the risk management service 210 may include a processing unit, internal system memory, and a suitable system bus for coupling various system components, including one or more data stores for storing information (e.g., files and metadata associated therewith). The risk management service 210 typically includes, or has access to, a variety of computer-readable media.

The computing system environment 200 is merely exemplary. While the risk management service 210 is illustrated as a single unit, it will be appreciated that the risk management service 210 is scalable. For example, the risk management service 210 may in actuality include a plurality of computing devices in communication with one another. Moreover, the data store 212, or portions thereof, may be included within, for instance, the risk management service 210 as a computer-storage medium. The single unit depictions are meant for clarity, not to limit the scope of embodiments in any form.

As shown in FIG. 2, the risk management service 210 comprises a receiving component 218, a nursing risk assessment component 220, a communication component 222, and a rendering component 224. In some embodiments, one or more of the components 218, 220, 222, and 224 may be implemented as stand-alone applications. In other embodiments, one or more of the components 218, 220, 222, and 224 may be integrated directly into the operating system of a computing device such as the remote computer 108 of FIG. 1. It will be understood that the components 218, 220, 222, and 224 illustrated in FIG. 2 are exemplary in nature and in number and should not be construed as limiting. Any number of components may be employed to achieve the desired functionality within the scope of embodiments hereof.

The receiving component 218 is configured to receive user selections, commands, filters, requests, or inputs. Additionally, the receiving component 218 is configured to receive updates to nursing risk assessment information and/or updates to the patient's EMR. The updates may occur when a healthcare facility modifies or adds nursing risk scenarios, risk factors or prevention measures, or when a patient's EMR is updated with new patient information. For the purposes of this application, a user may be defined as an employee of a healthcare facility, or a clinician associated with a healthcare facility (i.e., a clinician who has hospital privileges at the healthcare facility). In turn, a healthcare facility may comprise a hospital, an urgent care clinic, a clinician's office, a nursing home, a long-term care facility, a skilled nursing facility, a hospice facility, a rehabilitation facility, an occupational health clinic, a home health agency, a community health center, and the like. User selections and/or requests may include requests for one or more nursing risk assessments for a patient including a comprehensive nursing risk assessment.

The receiving component 218 may receive user selections and/or requests from a computing device associated with a first healthcare facility currently caring for a patient. The receiving component 218 may also receive user selections and/or requests from a computing device associated with a second healthcare facility scheduled to care for the patient concurrently with the first healthcare facility or after the patient is discharged from the first healthcare facility. For example, a common healthcare scenario involves a patient who is being treated at a hospital for injuries sustained during an accident. Instead, of being discharged home, the patient is discharged to a rehabilitation facility for further treatment. In this case, the hospital is the first healthcare facility, and the rehabilitation center is the second healthcare facility.

In general, the nursing risk assessment component 220 is configured to automatically, and without human intervention, perform nursing risks assessments for a plurality of different patients being cared for at a healthcare facility. A nursing risk assessment is a comprehensive evaluation of the patient's risk for one or more nursing risk scenarios based on the patient's medical records and interviews with the patient. In turn, a nursing risk scenario is a condition for which the patient is at risk unless appropriate nursing-related intervention or prevention measures are instituted. The nursing-related intervention or prevention measures are those that fall within the scope of a nurse's practice as defined by state law, and/or as defined by the healthcare facility where the nurse is employed. Exemplary nursing risk scenarios may include pressure ulcer risk, medication non-adherence risk, risk for readmission, risk for delirium or depression, risk for sun-downing, risk of restraints, risk of alcohol withdrawal, risk for falls, risk for ineffective nutrition, risk for domestic violence or alcohol/drug abuse, and the like. Appropriate nursing prevention measures run the gambit but may include monitoring and changing patient positions on a bed, monitoring patient nutrition, making sure the patient is taking certain medications, instituting various prophylactic measures, contacting other care team members or support staff, and the like.

With this as a background, the nursing risk assessment component 220 is configured to access a patient's electronic medical record at a healthcare facility (stored in association with the data store 212) and determine, using nursing risk assessment factors, whether the patient qualifies for one or more nursing risk scenarios. Each nursing risk scenario is associated with a set of nursing risk assessment factors. The set of nursing risk assessment factors may be facility specific or may be applicable to any number of healthcare facilities. Further, the nursing risk assessment factors may be stored in association with the data store 212.

The patient may qualify for a nursing risk scenario if information in the patient's EMR satisfies a predetermined number of the nursing risk assessment factors. By way of illustrative example, a set of nursing risk assessment factors for pressure ulcer risk may include paralysis, coma, obesity, being confined to bed for more than six hours at a time, immobility, chronic conditions such as diabetes or small artery disease, and skin integrity changes. A patient may qualify as at risk for pressure ulcers if the patient meets at least three of these factors. The patient information used to identify patient risk may be stored in disparate locations within the patient's EMR. The nursing risk assessment component 220 is also configured to take into account a patient's social history when determining if the patient qualifies as at risk for a nursing risk scenario. For instance, a disabled elderly man who typically lives at home by himself may qualify as being at risk for ineffective nutrition if the gentleman meets two of the risk factors. By contrast, a disabled elderly man who lives with his able-bodied wife may qualify as being at risk for ineffective nutrition if the gentleman meets four of the risk factors. The patient's social history is also stored in association with the patient's EMR.

In one aspect, the nursing risk assessment factors utilized by the nursing risk assessment component 220 may be dependent on demographic features associated with the patient. Demographic features may include age (pediatric versus adult), gender, the patient's country of origin, residence, ethnicity, and blood type. Nursing risk assessment factors may also be dependent upon features such as allergies, medications, genomic specifications, comorbidities, and time of year.

The nursing risk assessment component 220 is also configured to identify nursing risk prevention measures targeted to the nursing risk scenarios for which the patient qualifies. The nursing prevention measures are stored in association with the data store 212 and may be specific to a healthcare facility or may be applicable to any number of healthcare facilities. Nursing prevention measures may also be dependent on demographic features associated with the patient such as age or gender. For example, a different set of prevention measures may be identified for a pediatric patient as compared to a geriatric patient. The nursing risk assessment component 220 is further configured to aggregate the nursing risk scenarios for which the patient qualifies along with the identified nursing prevention measures to generate a comprehensive nursing risk assessment for the patient.

The communication component 222 is configured to communicate the comprehensive nursing risk assessment for the patient to other healthcare facilities that are or will be involved in the patient's care. In one aspect, the communication component 222 communicates the comprehensive nursing risk assessment only after receiving authorization from the patient and verifying that the patient is scheduled to be treated at the other healthcare facility. Further, the communication component 222 may communicate the comprehensive nursing risk assessment to the other healthcare facility only if the patient is to be treated at the other healthcare facility within a predetermined time frame such as within the next 30 days.

The rendering component 224 is configured to render and present the comprehensive nursing risk assessment on a user interface. The comprehensive nursing risk assessment may be presented in conjunction with other clinical applications such as a patient summary, and a clinician worklist. Patient summaries may include a general patient summary, an emergency department summary, a post-acute care summary, a nursing communication summary, and the like. The comprehensive nursing risk assessment may be presented on user interfaces associated only with nurses caring for the patient. Alternatively, the comprehensive nursing risk assessment may be presented on user interface associated with other clinicians who care for the patient beyond those in a nursing-type role. For instance, the comprehensive nursing risk assessment may be presented on user interfaces associated with physicians, therapists, pharmacists, social workers, and the like. Further, when the comprehensive nursing risk assessment is communicated to a second healthcare facility, the comprehensive nursing risk assessment is presented on a user interface associated with the second healthcare facility. The rendering component 224 is further configured to present nursing risk assessment information in the form of alerts, messages, reminders, and the like in the context of other healthcare applications and even in the context of non-clinical worklists that help healthcare facilities track aspects of patient risk.

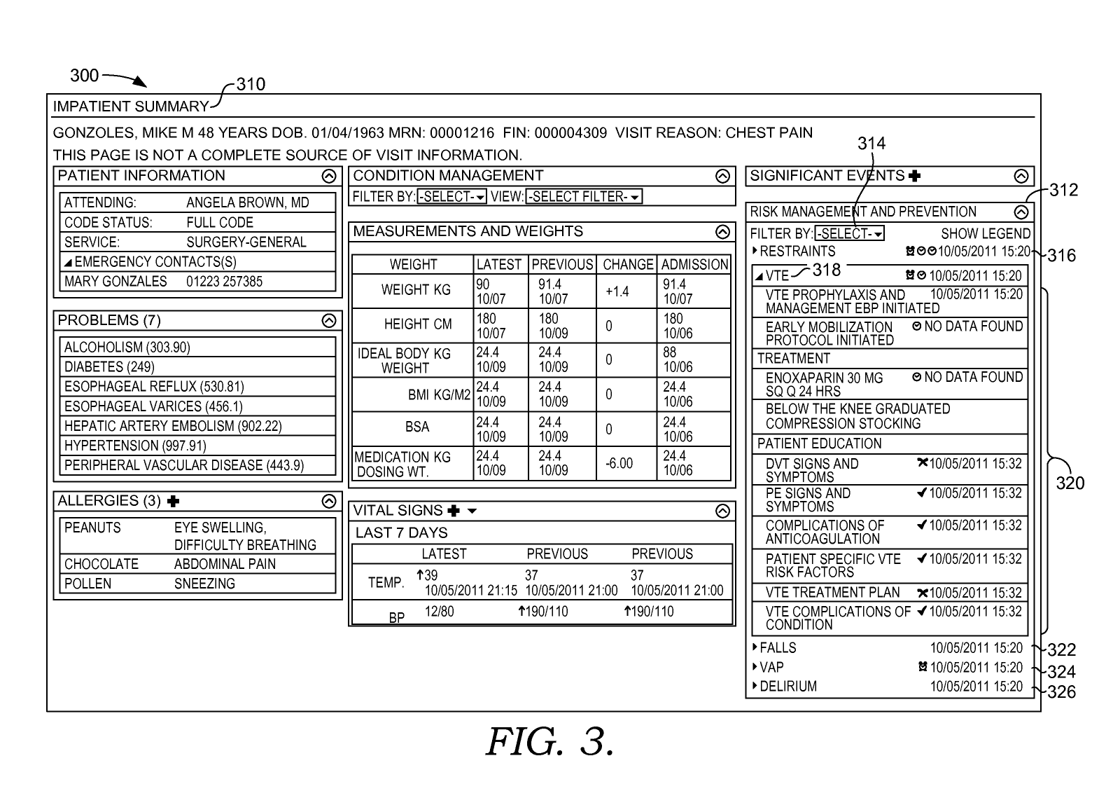

Turning now to FIG. 3, an exemplary graphical user interface (GUI) 300 is depicted illustrating a comprehensive nursing risk assessment in combination with a general patient summary. The GUI 300 includes an inpatient summary display area 310 for a patient (in this case, the patient is Mike Gonzoles) along with a comprehensive nursing risk assessment display area 312 (labeled as “Risk Management and Prevention”). The comprehensive nursing risk assessment display area 312 includes a filter area 314. The filter area 314 is used to quickly select different nursing risk scenarios for which the patient qualifies and view information about nursing risk prevention measures for the selected nursing risk scenario.

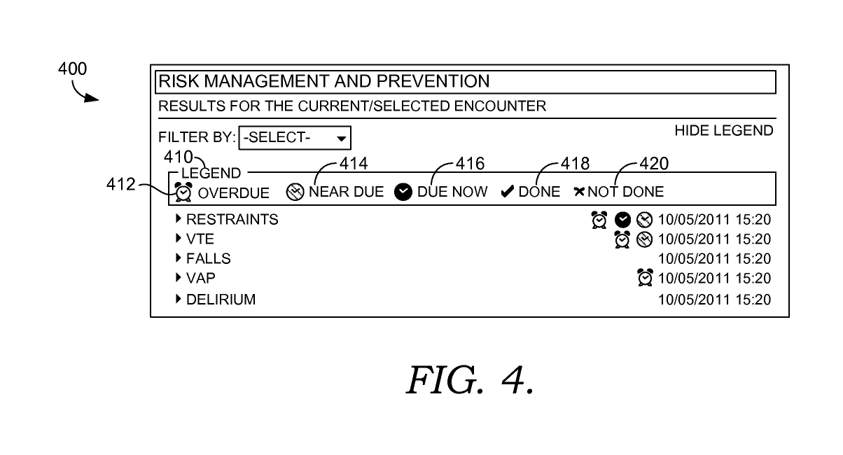

The comprehensive nursing risk assessment display area 312 further includes nursing risk scenarios for which the patient is at risk. In this case, the patient is at risk for restraints 316, veno-thrombo-embolism (VTE) 318, falls 322, ventilator-assisted pneumonia (VAP) 324, and delirium 326. Each of the risk scenarios 316, 318, 322, 324, and 326 includes one or more nursing prevention measures. The nursing prevention measures may be presented in response to the user selecting an associated nursing risk scenario in the filter area 314. As well, the nursing prevention measures may be presented upon the user selecting a header associated with at least one of the nursing risk scenarios 316, 318, 322, 324, or 326. For example, VTE nursing prevention measures 320 for the VTE risk scenario 318 are currently presented while the other prevention measures are hidden. Each prevention measure of the VTE prevention measures 320 may include one or more selectable icons. The meaning of the selectable icons will be explained with reference to FIG. 4.

The comprehensive nursing risk assessment display area 312 presented in conjunction with, for example, the inpatient summary display area 310 presents a holistic view of the patient—a view that captures the patient's medical information as well as assessment information that can be used to better guide patient care. For instance, a physician getting ready to discharge Mr. Gonzoles may note that Mr. Gonzoles not only suffers from alcoholism but has also been found to be at risk for falls and delirium. Instead of discharging the patient to his home, the physician may decide to discharge Mr. Gonzoles to a step-down facility that is better able to care for him. Further, the comprehensive nursing risk assessment 312 may be communicated to the step-down facility which enables the step-down facility to more quickly comprehend Mr. Gonzoles' many needs.

Turning now to FIG. 4, FIG. 4 depicts an exemplary excerpt from the GUI 300 and details the meaning of the different icons 410 presented in association with the comprehensive nursing risk assessment display area 312. The icons include an overdue icon 412, a near due icon 414, a due now icon 416, a done icon 418, and a not done icon 420. The overdue icon 412 indicates that an order, medication, procedure, intervention, etc. should have been completed during a particular time period, and that time period has expired. For example, restraint orders need to be renewed every 24 hours. If the restraint order is not renewed within the 24 hour time period, the overdue icon 412 is presented in association with restraint information. The near due icon 414 indicates that an order, medication, procedure, intervention, etc. is scheduled in the near future such as within the next four to six hours. The due now icon 416 indicates that an order, medication, procedure, and/or intervention is currently due.

The icons 410 further include the done icon 418. The done icon 418 provides a visual indication that a prevention measure has been completed. For example, some prevention measures only need to be performed once. These types of prevention measures commonly include educating the patient regarding the nursing risk scenario. Once the teaching has been completed, the done icon 418 is presented in association with the prevention measure. The not done icon 420 provides a visual indication that the prevention measure still needs to be executed. Hovering over or otherwise selecting the icons 410 presents additional information about the icon. Such information may include an amount of time left until an order expires, time elapsed since an order expired, reasons why a prevention measure has not been executed, and the like. Selection of one of the icons 410 may also initiate a link to, for example, appropriate ordering forms, pertinent patient documentation, and the like.

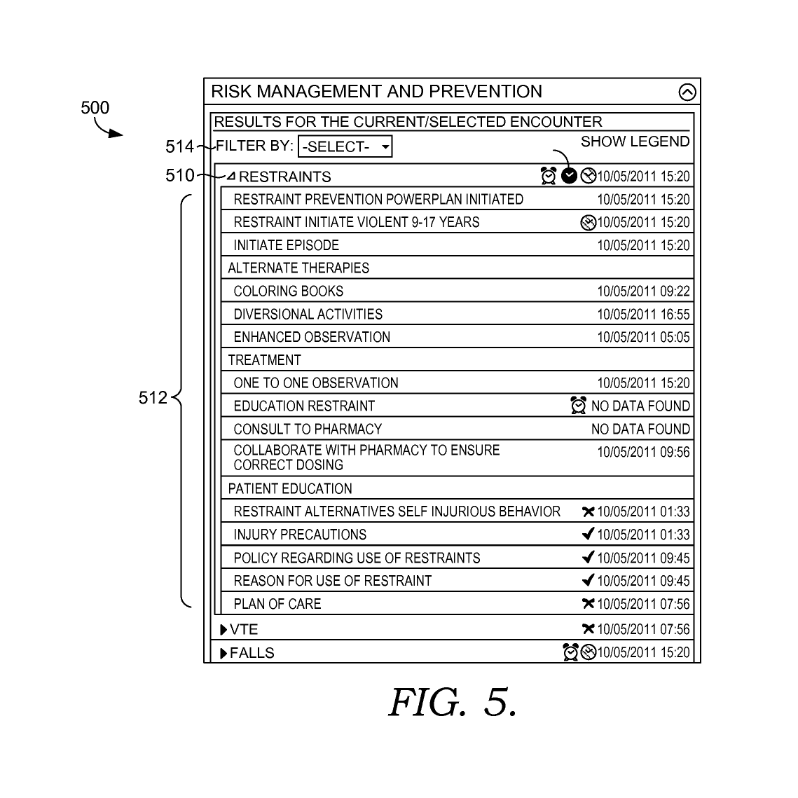

FIG. 5 presents an exemplary graphical user interface (GUI) illustrating a detailed view of a restraint risk scenario display area 510 in the context of a comprehensive nursing risk assessment display area 500. As mentioned earlier, each nursing risk scenario includes its own set of nursing risk prevention measures. The nursing risk prevention measures for the restraint risk scenario display area 510 are presented in area 512. Each of the prevention measures in the area 512 may be presented in association with one or more of the icons discussed above. Further, upon interaction with, for example, the header of the restraint risk scenario display area 510 via a mouse click or hover, additional information associated with the restraint risk display area 510 is presented. The additional information may include, for example, the reasons why the patient qualifies for the restraint risk scenario and information concerning the expiration of the restraint order. Selection of the header of the restraint risk scenario display area 510 also expands or collapses the prevention measures presented in the area 512. Although not shown, it is contemplated that prevention measures for each of the nursing risk scenarios in the comprehensive nursing risk assessment display area 500 may be presented upon selection of the appropriate header or upon selection of a nursing risk scenario in the filter area 514.

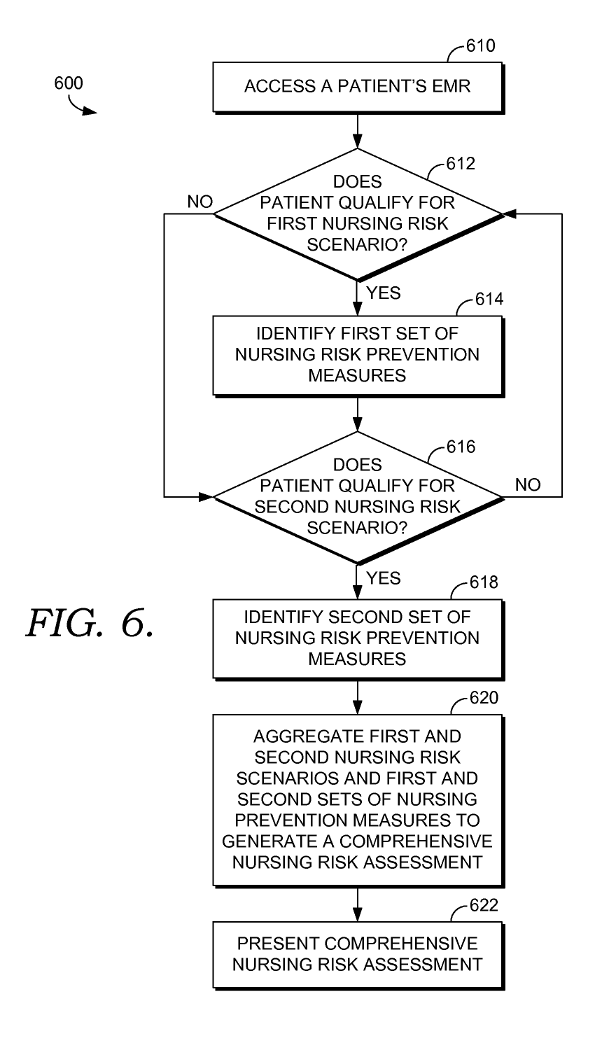

Turning now to FIG. 6, a flow diagram is depicted of an exemplary method 600 of generating a comprehensive nursing risk assessment. At a step 610, a patient's EMR is accessed by a nursing risk assessment component such as the nursing risk assessment component 220 of FIG. 2. The patient's EMR may be stored in association with a data store (e.g., the data store 212 of FIG. 2) and may be associated with a healthcare facility currently caring for the patient. The patient's EMR includes information concerning, for example, diagnoses, medical history, social history, and medications; this information is used by the nursing risk assessment component to determine if the patient qualifies for one or more nursing risk scenarios.

At a step 612, using the information in the patient's EMR, a first set of nursing risk assessment factors for a first nursing risk scenario is used to determine if the patient is at risk for the first nursing risk scenario. Representative nursing risk scenarios include risk for falls, risk for delirium, risk for VTE, risk for pressure ulcers, risk for medication non-adherence, risk for readmission, risk for VAP, risk for ineffective nutrition, and/or risk for depression.

The patient may be at risk for the first nursing risk scenario if the patient meets a predetermined number of the risk factors. In turn, the predetermined number may depend on, for example, the patient's social history and/or demographic information. As well, the first set of nursing risk assessment factors may depend on demographic features associated with the patient such as age or gender. By way of illustrative example, a different set of nursing risk assessment factors may be used to evaluate a pediatric patient for risk of falls as compared to a geriatric patient. The nursing risk assessment factors utilized in the step 612 may be specific to the healthcare facility currently caring for the patient. Alternatively, the nursing risk assessment factors may be standard nursing risk assessment factors.

If the patient qualifies as being at risk for the first nursing risk scenario, then, at a step 614, a first set of nursing prevention measures directed to the first nursing risk scenario is identified. The first set of nursing prevention measures is designed to reduce the likelihood of the first nursing risk scenario and comprises nursing-related interventions. The first set of nursing prevention measures may be specific to the healthcare facility or be standard nursing risk prevention measures. If, however, it is determined at the step 612 that the patient does not qualify for the first nursing risk scenario, the method 600 continues at a step 616.

At the step 616, using information in the patient's EMR, a second set of nursing risk assessment factors for a second nursing risk scenario is used to determine if the patient qualifies for the second nursing risk scenario; the second nursing risk scenario is different from the first nursing risk scenario. If the patient qualifies as being at risk for the second nursing risk scenario, then, at a step 618, a second set of nursing prevention measures directed to the second nursing risk scenario is identified.

However, if the patient does not qualify as being at risk for the second nursing risk scenario, the method 600 reverts back to the step 612, and the patient continues to be monitored for nursing risks. By continually monitoring patient information, any updates to the patient's EMR that increase the patient's risk for a nursing risk scenario are immediately detected. This reflects the reality of a patient's typical hospital stay. For example, a nursing assessment performed at the beginning of the hospital stay may indicate that a patient is not currently at risk for any nursing risk scenarios. However, the patient's course may alter during the stay, and the patient may become susceptible to one or more nursing risks. It is important to quickly and accurately capture this information in order to provide effective patient care.

At a step 620, the first and second nursing risk scenarios and the first and second sets of nursing prevention measures are used to generate a comprehensive nursing risk assessment for the patient. At a step 622, the comprehensive nursing risk assessment is presented on a user interface. The comprehensive nursing risk assessment may be presented in conjunction with other clinician workflows or applications such as a patient summary application, a clinical worklist application, and the like. As well, the user interface may be associated with a clinician other than a clinician in a nursing-type role. These may include, for example, therapists, speech pathologists, social workers, pharmacists, physicians, and the like. The user interface may also be associated with other healthcare facilities other than the healthcare facility currently caring for the patient. The other healthcare facilities may be scheduled to care for the patient after the patient is discharged. In another aspect, the other healthcare facilities may provide concomitant care for the patient along with the first healthcare facility. Any and all such aspects are contemplated as being within the scope of the invention.

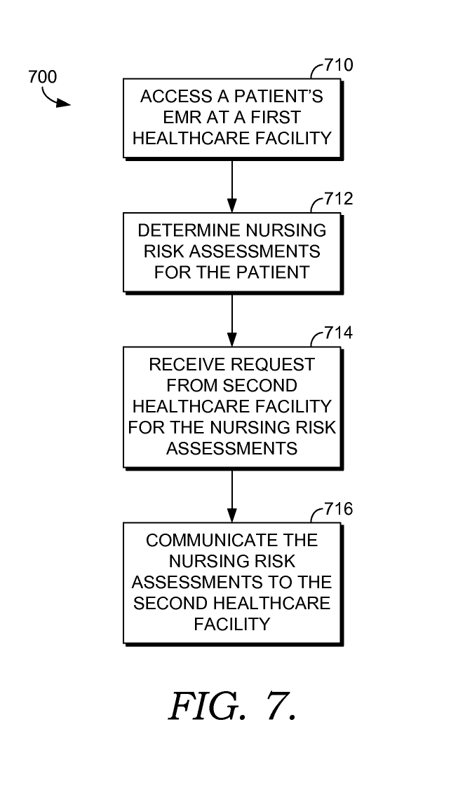

FIG. 7 depicts an exemplary flow diagram of a method 700 of generating a comprehensive nursing risk assessment at a first healthcare facility and communicating the comprehensive nursing risk assessment to a second healthcare facility. In one aspect, the first and second healthcare facilities are disparate healthcare facilities that maintain different electronic medical record keeping systems. The first and second healthcare facilities may include a nursing home, a hospital, a clinic, a long-term care facility, a home health agency, a hospice facility, a community medical outreach center, a rehabilitation facility, and the like. In one aspect, a patient's home may be considered a healthcare facility. For instance, there may be some interventions that the patient is expected to complete from home. The completion of the interventions may be recorded electronically from the patient's personal device to the patient's electronic medical record associated with a healthcare facility (e.g., the second healthcare facility).

At a step 710, the patient's EMR at a first healthcare facility is accessed; the patient is currently being treated at the first healthcare facility. At a step 712, using information stored in association with the patient's EMR, one or more nursing risk assessments are determined for the patient. The nursing risk assessments include nursing risk scenarios and corresponding nursing prevention measures.

At a step 714, a request for the nursing risk assessments is received from the second healthcare facility. The second healthcare facility may be scheduled to care for the patient after the patient is discharged from the first healthcare facility. In another aspect, the second healthcare facility is caring for the patient concurrently with the first healthcare facility. By way of illustrative example, the first healthcare facility may comprise a home health agency that provides in-home supportive care, and the second healthcare facility may comprise an occupational therapy group that also visits the patient in the patient's home to administer occupational therapy.

At a step 716, the nursing risk assessments are communicated to the second healthcare facility. The nursing risk assessments may not be communicated until after receiving authorization from the patient and verifying that the patient is scheduled to be treated or is currently being treated at the second healthcare facility. In one aspect, the patient is scheduled to be treated at the second healthcare facility within a predetermined time frame of being discharged from the first healthcare facility.

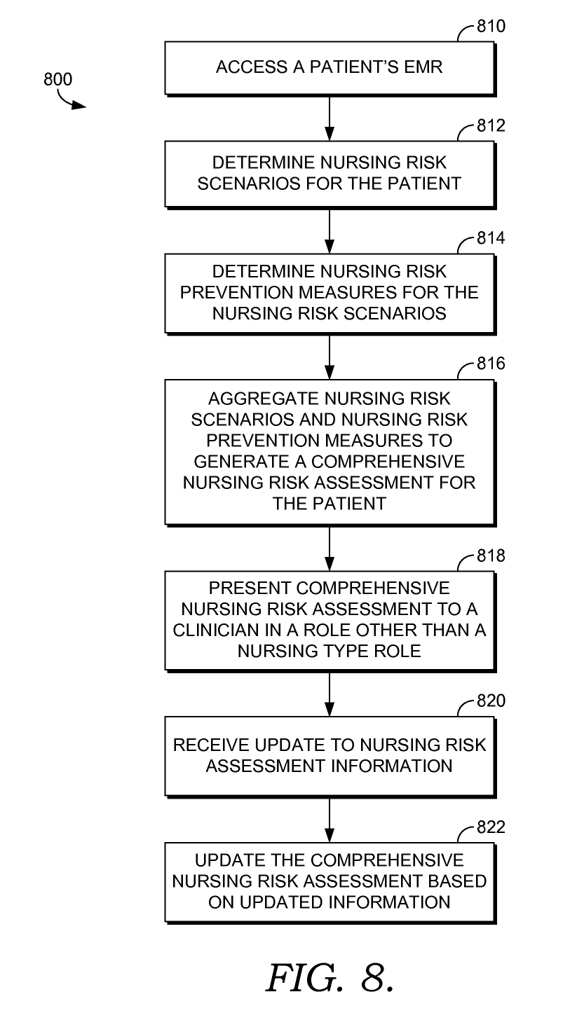

Turning to FIG. 8, a flow diagram is depicted of an exemplary method 800 of generating a comprehensive nursing risk assessment for a patient and presenting the nursing risk assessment to a clinician other than a nurse. At a step 810, information stored in association with a patient's EMR is accessed. The information may include the patient's medical history, diagnoses, social history, and/or medication history. Further, the information may be stored in disparate locations within the EMR.

At a step 812, the information is used to determine one or more nursing risk scenarios for the patient. For example, a set of nursing risk factors corresponding to a nursing risk scenario is identified and compared to the information in the EMR to determine if the patient qualifies for the nursing risk scenario. The patient may qualify if the patient meets a predetermined number of nursing risk factors within the set of nursing risk factors.

At a step 814, based on the nursing risk scenarios determined at the step 812, one or more nursing risk prevention measures are identified for the patient. And at a step 816, the nursing risk scenarios and the nursing risk prevention measures are aggregated and used to generate a comprehensive nursing risk assessment for the patient. At a step 818, the comprehensive nursing risk assessment is presented on a user interface associated with a clinician other than a clinician in a nursing-type role. As mentioned above, other roles may include physician, therapist, social worker, pharmacist, and the like.

At a step 820, one or more updates to the nursing risk scenarios, the nursing risk prevention measures, and/or the patient's EMR are received by a receiving component such as the receiving component 218 of FIG. 2. Updates to nursing risk scenarios may include newly recognized nursing risk scenarios or updates to current nursing risk assessment factors. The updates to the nursing risk scenarios and/or nursing risk prevention measures may occur in response to changes at a facility level or changes at a national level. For instance, a nationally-recognized medical organization may issue new prevention measures for certain risk scenarios; these new prevention measures are adopted by the healthcare facility. At a step 822, the one or more updates are used to update the comprehensive nursing risk assessment for the patient. In this manner, clinicians are always presented with the most up-to-date risk assessment information for their patients.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. One or more computer storage media having computer-executable instructions embodied thereon that, when executed, cause a computing device to perform a method of generating a comprehensive nursing risk assessment for a patient being cared for at a first healthcare facility, the method comprising:
accessing an electronic medical record (EMR) associated with the patient;
using a first set of nursing risk assessment factors for a first nursing risk scenario and using information stored in the patient's EMR, determining that the patient qualifies for the first nursing risk scenario;
identifying a first set of nursing risk prevention measures directed to the first nursing risk scenario;
using a second set of nursing risk assessment factors for a second nursing risk scenario and using information stored in the patient's EMR, determining that the patient qualifies for the second nursing risk scenario;
identifying a second set of nursing risk prevention measures directed to the second nursing risk scenario;
aggregating the first nursing risk scenario, the first set of nursing risk prevention measures, the second nursing risk scenario, and the second set of nursing risk prevention measures to generate a comprehensive nursing risk assessment for the patient; and
presenting the comprehensive nursing risk assessment on a user interface.

2. The media of claim 1, wherein at least one of the first or second sets of nursing risk assessment factors is dependent on one or more demographic characteristics of the patient, the one or more demographic characteristics including at least age or gender.

3. The media of claim 1, wherein a nursing risk scenario comprises one or more selected from the following:
risk for falls;
risk for delirium;
risk for veno-thrombo-embolism (VTE);
risk for pressure ulcers;
risk for medication non-adherence;
risk for ventilator-associated pneumonia (VAP);
risk for ineffective nutrition; and
risk for depression.

4. The media of claim 1, wherein at least one of the first or second sets of nursing risk assessment factors is specific to the first healthcare facility.

5. The media of claim 1, wherein the comprehensive nursing risk assessment for the patient is presented in association with a general patient summary.

6. The media of claim 1, wherein the comprehensive nursing risk assessment for the patient is presented in association with a clinician worklist.

7. The media of claim 1, wherein the user interface is associated with a clinician other than a clinician in a nursing role.

8. One or more computer storage media having computer-executable instructions embodied thereon that, when executed, cause a computing device to perform a method of sharing a patient's nursing risk assessment across different healthcare facilities involved in the patient's care, the method comprising:
accessing an electronic medical record (EMR) associated with the patient, wherein the EMR is at a first healthcare facility, and wherein the patient is currently being treated at the first healthcare facility;
using information stored in association with the patient's EMR, determining one or more nursing risk assessments for the patient at the first healthcare facility;
receiving a request from a second healthcare facility for the one or more nursing risk assessments, wherein the patient is scheduled to be treated at the second healthcare facility at a future point in time; and
communicating the one or more nursing risk assessments to the second healthcare facility.

9. The media of claim 8, wherein the first healthcare facility and the second healthcare facility are disparate healthcare facilities.

10. The media of claim 8, wherein the second healthcare facility comprises one or more selected from the following:
a nursing home;
a long-term care facility;
a home health agency;
a hospice facility; and
a rehabilitation facility.

11. One or more computer storage media having computer-executable instructions embodied thereon that, when executed, cause a computing device to perform a method of creating a comprehensive nursing risk assessment for a patient and making the comprehensive nursing risk assessment available to clinicians caring for the patient, the method comprising:
accessing an electronic medical record (EMR) associated with the patient;
using information stored in association with the EMR, determining one or more nursing risk scenarios for the patient;
based on the one or more nursing risk scenarios for the patient, determining one or more nursing risk prevention measures for the patient;
aggregating the one or more nursing risk scenarios and the one or more nursing risk prevention measures to generate a comprehensive nursing risk assessment for the patient;
presenting on a user interface associated with a clinician the comprehensive nursing risk assessment, the clinician in a role other than a nursing role;
receiving one or more updates to at least one of the information stored in association with the EMR, the one or more nursing risk scenarios, or the one or more nursing risk prevention measures; and
using the updates, updating the comprehensive nursing risk assessment.

12. The media of claim 11, wherein the information stored in association with the EMR is stored in disparate locations within the EMR.

13. The media of 12, wherein the information includes a medical history, diagnoses, medication history, and social history.

14. The media of claim 11, wherein the determining the one or more nursing risk scenarios comprises:
for a first nursing risk scenario of the one or more nursing risk scenarios:
(A) identifying a set of nursing risk factors corresponding to the first nursing risk scenario; and
(B) comparing the set of nursing risk factors to the information stored in association with the EMR to determine that the patient is at risk for the first nursing risk scenario.

15. The media of claim 14, wherein the patient is at risk for the first nursing risk scenario when the patient meets a predetermined number of nursing risk factors in the set of nursing risk factors.

16. The media of claim 11, wherein the one or more nursing risk prevention measures comprises actions undertaken undertaken by a nurse to reduce a likelihood of occurrence of the one or more nursing risk scenarios.

17. The media of claim 11, further comprising:
receiving a selection on the user interface of at least one of the one or more nursing risk scenarios included within the comprehensive nursing risk summary; and
incident to receiving the selection, presenting information about why the patient is at risk for the at least one of the one or more nursing risk scenarios.

18. The media of claim 11, further comprising:
receiving a selection on the user interface of at least one of the one or more nursing risk scenarios included within the comprehensive nursing risk summary; and
incident to receiving the selection, presenting information about one or more clinician orders associated with the at least one of the one or more nursing risk scenarios.

19. The media of claim 18, wherein the information comprises when the one or more clinician orders expire.

20. The media of claim 11, further comprising:
receiving a selection on the user interface of at least one of the one or more nursing risk scenarios included within the comprehensive nursing risk summary; and
presenting information associated with at least one of the one or more nursing risk prevention measures associated with the at least one of the one or more nursing risk scenarios.
